(19) United States
(12) Patent Application Publication
(10) Pub. No.: US 2026/0180084 A1
(43) Pub. Date: Jun. 25, 2026

(54) EXPLOSION-PROOF BATTERY FOR ELECTRIC VEHICLE AND ELECTRIC GOLF TROLLEY USING SAME

(71) Applicant: CADDIESTER GOLF BUGGY TECHNOLOGY LTD., Changzhou (CN)

(72) Inventors: Jiaxiong Gong, Changzhou (CN); Qian Gong, Changzhou (CN)

(73) Assignee: CADDIESTER GOLF BUGGY TECHNOLOGY LTD., Changzhou (CN)

(21) Appl. No.: 19/429,096

(22) Filed: Dec. 22, 2025

(30) Foreign Application Priority Data
Dec. 23, 2024 (CN) 2024231835073

(51) Int. Cl. H01M 50/143; H01M 50/107; H01M 50/141; H01M 50/152; H01M 50/333

(52) U.S. Cl. CPC H01M 50/143; H01M 50/107; H01M 50/141; H01M 50/152; H01M 50/333; H01M 2220/20

(57) ABSTRACT

The present disclosure relates to an explosion-proof battery for electric vehicles and an electric golf trolley. The explosion-proof battery includes a battery case, a closure plate and a cell assembly, wherein at least one vent is disposed in the battery case; and when a gas pressure in a cavity in which the cell assembly is located rises, gas is discharged to an outside of the battery case through the vent. The explosion-proof battery of the present disclosure enables gas generated by the explosion to be discharged, thereby limiting the combustion and explosion of the cell assembly in the battery case, and improving the safety performance

### TECHNICAL FIELD

The present disclosure belongs to the technical field of explosion-proof batteries, and particularly relates to an explosion-proof battery for electric vehicles and an electric golf trolley using the same.

### BACKGROUND

With the development of modern science and technology, a lithium ion battery such as a ternary lithium battery and a lithium iron phosphate battery can provide an energy source for electronic devices at any time, and thus is widely used, and the electronic devices are, for example, various types of electric vehicles, particularly including electric bicycles, electric motorcycles, electric tricycles, electric golf trolleys, and the like. The electric bicycles, the electric motorcycles and the electric tricycles are all transportation vehicles powered by a storage battery such as a lithium battery and driven by a motor, while the golf trolleys are used to carry golf bags for placing golf clubs and the like, and the electric golf trolley powered by a lithium battery can use electric drive instead of manual labor, making it more convenient and labor-saving to use.

Existing lithium-ion batteries may trigger thermal runaway conditions if they are subjected to mechanical damage, thermal management failure, overcharging and overdischarging during handling, storage, or charging. After the thermal runaway is triggered, a large amount of high-temperature combustible mixed gas or the like will be generated, and a closed space of a case may cause the generated heat and gas to be unable to be discharged in time, which can easily lead to an explosion, endangering personal and property safety.

### SUMMARY

An object of the present disclosure is to provide an explosion-proof battery for electric vehicles and an electric golf trolley using the same, so as to solve the problem that a battery is prone to explosion hazards.

An explosion-proof battery for electric vehicles and an electric golf trolley using the same of the present disclosure are implemented as follows:
an explosion-proof battery for electric vehicles includes:
a battery case, wherein a cell assembly is mounted in the battery case; and
at least one closure plate, wherein one side, facing away from a cavity in which the cell assembly is located, of each closure plate is correspondingly provided with at least one vent located in the battery case; and
in a normal state, the vent and the cavity in which the cell assembly is located are respectively located at both sides of the closure plate corresponding to the vent, and the closure plate can isolate spaces on both sides, i.e., the cavity in which the cell assembly is located and a space (a venting cavity) corresponding to the vent, to a certain extent.

When a gas pressure in the cavity in which the cell assembly is located rises, the closure plate moves toward the side at which the vent is located, so that gas in the cavity in which the cell assembly is located is discharged to an outside of the battery case through the vent; and
when the gas pressure in the cavity in which the cell assembly is located decreases, the closure plate moves toward the side at which the cell assembly is located until the cavity in which the cell assembly is located is separated from the vent.

Further, the battery case includes a cylindrical outer case, and end plates disposed at both ends of the outer case, the closure plate is located at an inner side of the end plate, and a venting cavity is disposed between the closure plate and the end plate at an end where the closure plate is disposed.

One closure plate may be provided, that is, the closure plate is located at an inner side of the end plate at either end, and the corresponding vent is located in the battery case outside the closure plate; and
two closure plates may be provided and are respectively located at inner sides of the two end plates, and the vents are disposed in the battery case outside the corresponding closure plates.

The battery case may adopt an integral structure, i.e., the cylindrical outer case and the end plates at both ends of the outer case are integrally formed; and the battery case may also adopt a split structure, i.e., the cylindrical outer case is matched with the end plates at both ends of the outer case by welding or bolted connection or the like.

Further, the vent is disposed in an outer wall of the venting cavity.

Further optionally, the vent is disposed in the outer case.

Further optionally, the vent is disposed in the end plate, in particular the end plate at the end where the closure plate is located.

Further, elastic elements are disposed between the closure plate and the end plate at the end where the closure plate is located

The function of the elastic elements is to give the closure plate an initial thrust, so that the closure plate can separate the cavity in which the cell assembly is located from the venting cavity in the normal state; and in the case where the gas pressure in the cavity in which the cell assembly is located rises, the closure plate can move toward the side at which the venting cavity is located against the thrust of the elastic elements so that gas in the cavity in which cells are located is discharged to the outside of the battery case through the vent.

The elastic element may be selected from any conventional component capable of providing suitable elasticity.

The elastic elements may be arranged in any number at any position between the closure plate and the corresponding end plate, as long as it is achieved that the closure plate can substantially separate the cavity in which the cell assembly is located from the venting cavity under normal circumstances; and in the case where the gas pressure in the cavity in which the cell assembly is located rises, the closure plate can move in a direction of the venting cavity (in a direction away from the cell assembly) against the thrust of the elastic elements.

In general, a better effect may be achieved by arranging the elastic elements in a symmetrical or uniform manner.

Further, each elastic element is a spring; and
the spring is assembled on the closure plate and/or the end plate corresponding thereto.

Further, convex posts are disposed on an inner wall of the end plate at the end where the closure plate is located, the closure plate is provided with through holes for accommodating the convex posts to pass through, and each spring sleeves the corresponding convex post.

Further, each elastic element is an elastic piece; and
at least one end of the elastic piece is mounted on the closure plate or the end plate corresponding thereto.

Further, a moving travel range of the closure plate is 1.5-4 mm.

Further, an inner side of the closure plate is provided with a supporting plate, and a plurality of vent windows are disposed in the supporting plate;
under normal circumstances, the closure plate is attached to an outer surface of the supporting plate, and the supporting plate plays a supporting and limiting role for the closure plate. In this state, the closure plate can separate, but not completely separate, the space in which the cell assembly is located (i.e., an inner portion of the supporting plate) from the venting cavity to a certain extent, the gas can still pass through a gap between the closure plate and the supporting plate; and
when the gas pressure in the cavity in which the cell assembly is located rises, the closure plate moves toward the side at which the venting cavity is located against the thrust of the elastic elements to enlarge the gap between the closure plate and the supporting plate to form a smooth venting passage, and at this time, the gas in the cavity in which the cell assembly is located enters the venting cavity and is quickly discharged from the vent to the outside of the battery case.

An inner surface of the supporting plate is provided with a plurality of reinforcing ribs.

Further, a top and a bottom of the cell assembly each are provided with a vent channel.

Further, the vent is provided with a waterproof plug, and the waterproof plug moves outwardly to be disengaged from the vent when the gas pressure in the cavity in which the cell assembly is located rises.

Further, the end plate at an end not provided with the closure plate is externally provided with a connector box, and a lithium battery plug is disposed inside the connector box.

Further, a charging interface of the lithium battery plug is located at an end of the explosion-proof battery, and a discharging interface of the lithium battery plug is located at a bottom of the explosion-proof battery; and
wire passing holes are disposed in the end plate at the end where the connector box is located, and a power wire of the lithium battery plug is connected to the cell assembly through the wire passing holes.

Further, the connector box is provided with a locking protrusion capable of extending from a top of the explosion-proof battery, the locking protrusion is provided with a release tab extending from an inside of the connector box, and a top of the locking protrusion is provided with a locking spring.

Further, the battery case is made of a metal sheet material.

Preferably, the battery case is made of an aluminum alloy plate, which is light in weight and high in strength.

Further, the explosion-proof battery for electric vehicles is applied to an electric golf trolley.

Secondly, the present disclosure also provides an electric golf trolley based on the above explosion-proof battery for electric vehicles, the electric golf trolley using the above explosion-proof battery for electric vehicles.

After adopting the above technical solutions, the present disclosure has the following beneficial effects:
In the present disclosure, the vent is formed in the battery case, and the vent is matched with the closure plate in the battery case, and when thermal runaway occurs in the cell assembly, the gas pressure in the cavity in which the cell assembly is located rises, gas pushes the closure plate to move to communicate the cavity in which the cell assembly is located with the vent, so that gas generated by the explosion is discharged from the vent to the outside of the battery case, thereby limiting the combustion and explosion of the cell assembly in the battery case, preventing explosives from being splashed out, preventing the fire situation, and improving the safety performance.

### BRIEF DESCRIPTION OF THE DRAWINGS

The present disclosure is further described below with reference to the accompanying drawings and embodiments.

FIG. 1 is a structural diagram of an explosion-proof battery for electric vehicles in Embodiment 1 of the present disclosure;

FIG. 2 is a structural diagram of the explosion-proof battery for electric vehicles in Embodiment 1 of the present disclosure;

FIG. 3 is a sectional view of the explosion-proof battery for electric vehicles in Embodiment 1 of the present disclosure;

FIG. 4 is an enlarged view of a portion A in FIG. 3;

FIG. 5 is an exploded schematic view of one end (one end with a closure plate) of an explosion-proof battery case of the explosion-proof battery for electric vehicles in Embodiment 1 of the present disclosure;

FIG. 6 is an exploded schematic view of the other end of the explosion-proof battery case of the explosion-proof battery for electric vehicles in Embodiment 1 of the present disclosure;

FIG. 7 is a structural diagram of an explosion-proof battery for electric vehicles in Embodiment 4 of the present disclosure;

FIG. 8 is an exploded schematic view of one end (one end with a closure plate) of an explosion-proof battery case of the explosion-proof battery for electric vehicles in Embodiment 4 of the present disclosure;

FIG. 9 is an exploded schematic view of one end (one end with the closure plate) of the explosion-proof battery case of the explosion-proof battery for electric vehicles in Embodiment 4 of the present disclosure; and

FIG. 10 is a structural diagram of the other end of the explosion-proof battery case of the explosion-proof battery for electric vehicles in Embodiment 4 of the present disclosure;

In the figures: battery case 1, outer case 1-1, end plate 1-2, cell assembly 2, closure plate 3, vent 4, vent hole 5, venting cavity 6, sealing screw 7, spring 8, convex post 9, through hole 10, round table 11, supporting plate 12, vent window 13, recessed groove 14, reinforcing rib 15, vent channel 16, waterproof plug 17, connector box 18, lithium battery plug 19, screw 20, charging interface 21, discharging interface 22, wire passing hole 23, locking protrusion 24, release tab 25, locking spring 26, first flange 27, second flange 28, step 29, fixed plate 30, ramp

### DETAILED DESCRIPTION

In order to make the objects, technical solutions and advantages of the embodiments of the present disclosure more clear, the technical solutions in the embodiments of the present disclosure will be clearly and completely described below in conjunction with the accompanying drawings in the embodiments of the present disclosure. Obviously, the embodiments described are some embodiments of the present disclosure, but not all embodiments of the present disclosure. Based on the embodiments in the present disclosure, all other embodiments obtained by those of ordinary skill in the art without making inventive step belong to the scope of protection of the present disclosure.

Thus, the following detailed description of the embodiments of the present disclosure provided in the drawings is not intended to limit the scope of the present disclosure as claimed, but merely represents selected embodiments of the present disclosure. Based on the embodiments in the present disclosure, all other embodiments obtained by those of ordinary skill in the art without making inventive step belong to the scope of protection of the present disclosure.

### Embodiment 1

In this embodiment, the explosion-proof battery for electric vehicles is applied to various electric golf trolleys.

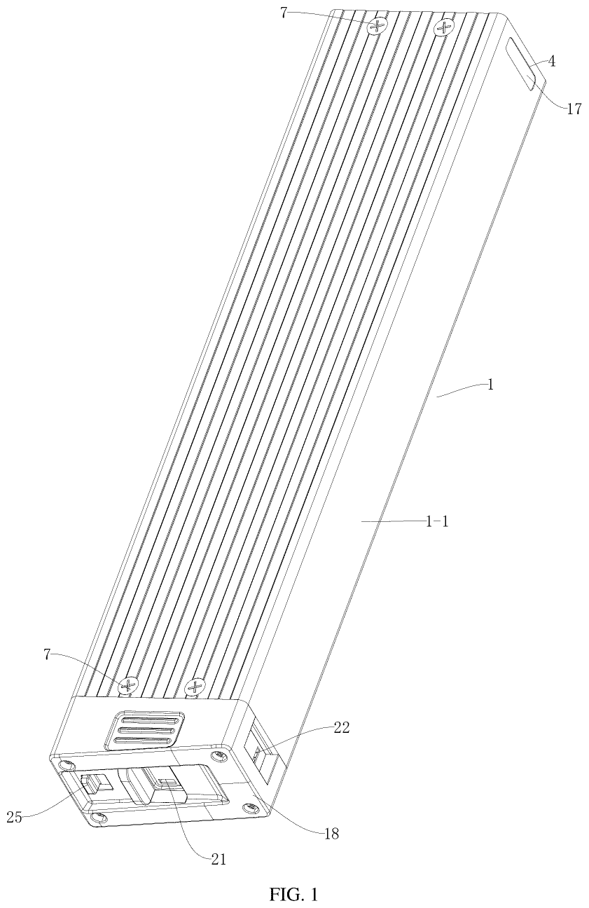

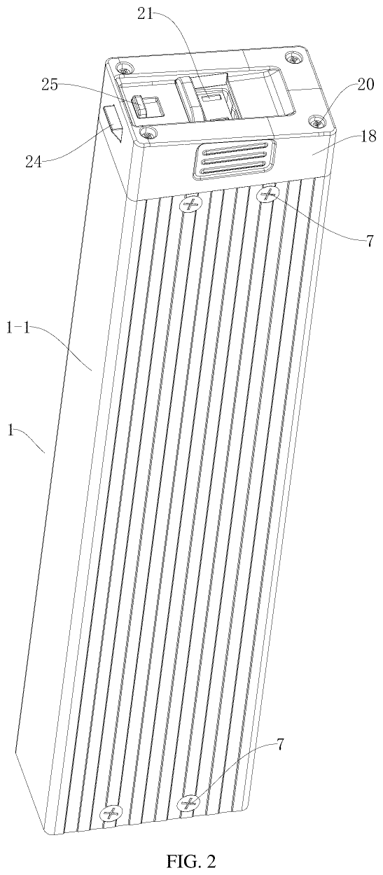

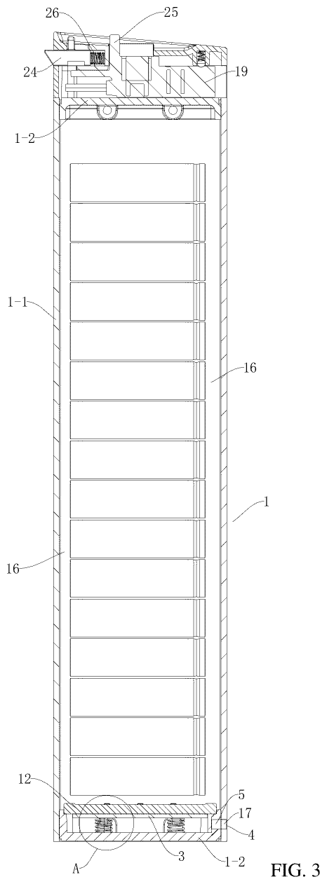

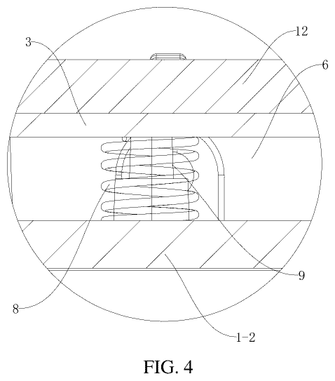

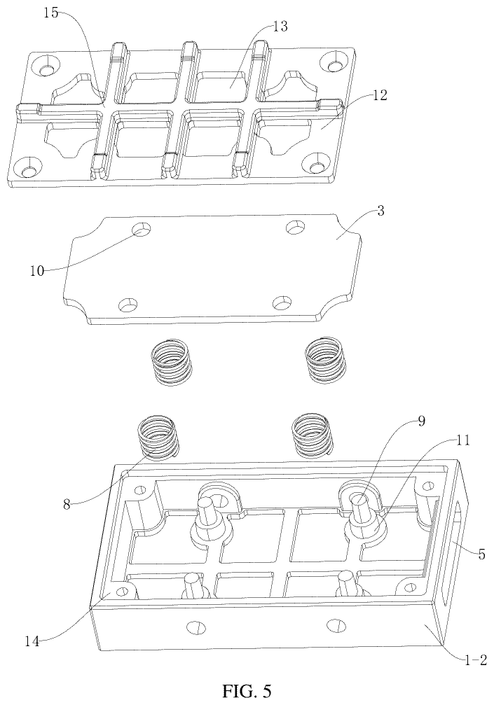

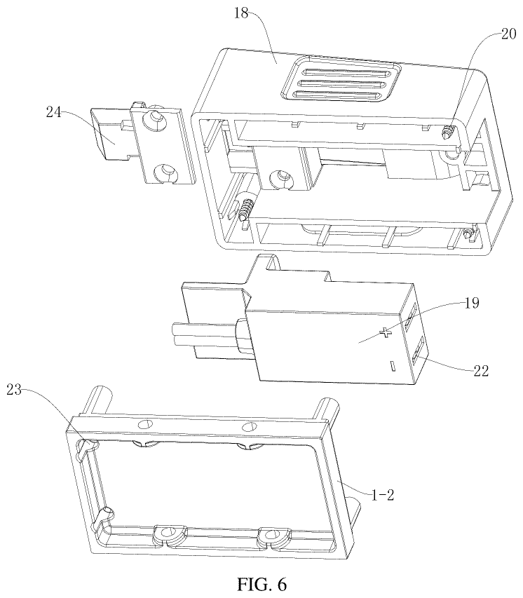

As shown in FIGS. 1 to 6, an explosion-proof battery for electric vehicles includes a battery case 1, a cell assembly 2 and at least one closure plate 3, wherein the cell assembly 2 is mounted inside the battery case 1; one side, facing away from a cavity in which the cell assembly 2 is located, of each closure plate 3 is correspondingly provided with at least one vent 4 located in the battery case 1; when a gas pressure in the cavity in which the cell assembly 2 is located rises, the closure plate 3 moves toward the side at which the vent 4 is located, so that gas in the cavity in which the cell assembly 2 is located is discharged to an outside of the battery case 1 through the vent 4; and when the gas pressure in the cavity in which the cell assembly 2 is located decreases, the closure plate 3 moves toward the side at which the cell assembly 2 is located until the cavity in which the cell assembly 2 is located is separated from the vent 4.

The battery case 1 includes a cylindrical outer case 1-1, and end plates 1-2 disposed at both ends of the outer case 1-1, the closure plate 3 is disposed on an inner side of the end plate 1-2, and a venting cavity 6 is disposed between the closure plate 3 and the end plate 1-2 at an end where the closure plate 3 is located.

Since the explosion-proof battery in this embodiment has a small capacity, the effect of quickly discharging gas in the battery case 1 can be achieved by providing one closure plate 3. Therefore, in this embodiment, one closure plate 3 is provided and is located at the inner side of one of the end plates 1-2, and accordingly, the vent 4 is located in the battery case 1 outside the closure plate 3.

The provision of the venting cavity 6 can reserve a space for the movement of the closure plate 3 when the gas pressure in the cavity in which the cell assembly 2 is located rises.

The battery case 1 may adopt an integral structure, i.e., the cylindrical outer case 1-1 and the end plates 1-2 at both ends of the outer case 1-1 are integrally formed, or the battery case 1 may adopt a split structure, i.e., the cylindrical outer case 1-1 is matched with the end plates 1-2 at both ends of the outer case 1-1 by welding or bolted connection or the like. In this embodiment, the split structure is used, and is more convenient to manufacture.

Specifically, in order to ensure the waterproof performance of the explosion-proof battery, a sealing fit is required between the outer case 1-1 and the end plates 1-2, and in this embodiment, the outer case 1-1 is a rectangular column structure opened at both ends, and each end plate 1-2 has a groove structure opened at one side. During assembly, the end plates 1-2 are mounted in the end openings of the outer case 1-1 with the openings facing inward, and then sealing screws 7 pass through the outer case 1-1 and are connected to side walls of the end plates 1-2 by using screws 20. If necessary, a waterproof sealant may be applied to a position where the end plates 1-2 are matched with the outer case 1-1 to ensure the waterproof sealing performance of the explosion-proof battery.

The vent 4 is disposed in an outer wall of the venting cavity 6.

In this embodiment, the vent 4 is disposed in the outer case 1-1.

A side wall of the end plate 1-2 at the end where the closure plate 3 is located is provided with a vent hole 5 opposite to the vent 4 to ensure that gas entering the venting cavity 6 from the space in which the cell assembly 2 is located can be discharged to the outside of the battery case 1 through the vent 4.

In order to ensure the gas discharge efficiency in the explosion-proof battery, an area of the vent 4 in the explosion-proof battery is not less than 100 mm², and one vent 4 may be provided, or two or more vents 4 may be provided, and in this embodiment, one rectangular vent 4 is provided.

Under normal circumstances, the venting cavity 6 corresponding to the vent 4 and the cavity in which the cell assembly 2 is located are respectively located at both sides of the closure plate 3, and the closure plate 3 can separate the two spaces to a certain extent; when the gas pressure in the cavity in which the cell assembly 2 is located rises due to thermal runaway explosion or the like, the closure plate 3 moves toward the side at which the venting cavity 6 is located, and at this time, the venting cavity 6 and even the vent 4 will be located at the same side of the closure plate 3 as the cavity in which the cell assembly 2 is located. The vent 4 can quickly discharge the gas in the cavity in which the cell assembly 2 is located to the outside of the battery case 1. In the above venting process, the gas in the cavity in which the cell assembly 2 is located will impact the closure plate 3 from the front, and then turn to be discharged from an outer edge of the closure plate 3 into the venting cavity 6. In this process, the gas undergoes a turn, which can effectively prevent the gas from being directed toward the vent 4, thereby better limiting the combustion and explosion of the cell assembly 2 in the battery case 1, preventing explosives from being splashed out, preventing the fire situation, and improving the safety performance.

Elastic elements are disposed between the closure plate 3 and the end plate 1-2 at the end where the closure plate 3 is located.

The elastic elements provide an initial thrust for the closure plate 3 to separate the venting cavity 6 from the cavity in which the cell assembly 2 is located; secondly, when the explosion of the cell assembly 2 ends or during the explosion interval stage, the gas pressure in the cavity in which the cell assembly 2 is located decreases, and the closure plate 3 moves toward the cavity in which the cell assembly 2 is located under the action of the elastic force of the elastic elements until the closure plate 3 is fully reset (i.e., the closure plate 3 again separates the venting cavity 6 from the cavity in which the cell assembly 2 is located), thereby preventing external air from entering the cavity in which the cell assembly 2 is located and causing the fire situation.

In this embodiment, each elastic element is a spring 8.

In particular, four springs 8 are provided, and are arranged symmetrically close to four corners of the closure plate 3, so as to ensure stability of the closure plate 3 during movement and avoid the problem of deviation.

A spring force of a single spring is 9N, and the spring force is 30-40N when the four springs 8 are compressed, i.e., when the gas pressure in the cavity in which the cell assembly 2 is located is greater than the corresponding elastic force of the springs, the closure plate 3 can be pushed to move toward the side at which the venting cavity 6 is located, so as to facilitate discharging the gas in the cavity in which the cell assembly 2 is located from the vent 4.

In order to enable the positioning of the springs 8, the springs 8 are assembled on the closure plate 3 and/or the end plate 1-2 corresponding thereto.

In particular, convex posts 9 are disposed on an inner wall of the end plate 1-2 at the end where the closure plate 3 is located, the closure plate 3 is provided with through holes 10 for accommodating the convex posts 9 to pass through, and each spring 8 sleeves the corresponding convex post 9.

The matching of the convex posts 9 with the through holes 10 can guide the movement of the closure plate 3, while the convex posts 9 can also facilitate the assembly of the springs 8.

Preferably, one end, facing the closure plate 3, of each convex post 9 is provided with a circular table 11 with a slightly larger outer diameter, each spring 8 is assembled outside the corresponding circular table 11 so that the springs 8 can be positioned to prevent free movement of the springs 8 in a radial direction, while the circular tables 11 are provided so as to limit the movement of the closure plate 3 toward the end plate 1-2, i.e., when the closure plate 3 is attached to the circular tables 11, the closure plate 3 cannot continue to move toward the side where the end plate 1-2 is located.

A moving travel range of the closure plate 3 is 1.5-4 mm.

An inner side of the closure plate 3 is provided with a supporting plate 12, and the supporting plate 12 is provided with a plurality of vent windows 13.

The provision of the supporting plate 12 can support and limit the inner side of the closure plate 3, and the provision of the vent windows 13 can ensure that the gas in the cavity in which the cell assembly 2 is located can be smoothly discharged to the outside of the battery case 1.

Specifically, under normal circumstances, the closure plate 3 is attached to an outer surface of the supporting plate 12, and the supporting plate 12 plays a supporting and limiting role for the closure plate 3. In this state, the closure plate 3 can separate, but not completely separate, the space in which the cell assembly 2 is located (i.e., an inner portion of the supporting plate 12) from the venting cavity 6 to a certain extent, the gas can still pass through a gap between the closure plate 3 and the supporting plate 12.

When the gas pressure in the cavity in which the cell assembly 2 is located rises, the closure plate 3 moves toward the side where the venting cavity 6 is located against the thrust of the elastic elements to enlarge the gap between the closure plate 3 and the supporting plate 12 to form a smooth venting passage, and at this time, the gas in the cavity in which the cell assembly 2 is located enters the venting cavity 6 and is quickly discharged from the vent 4 to the outside of the battery case 1.

In this embodiment, the supporting plate 12 is assembled on the end plate 1-2 at the end where the supporting plate 12 is located, i.e., an inner side of a side plate of the end plate 1-2 is provided with a recessed groove 14, and the supporting plate 12 is placed in the recessed groove 14 and is connected to the end plate 1-2 by means of bolts.

In order to guarantee the structural strength of the supporting plate 12, and an inner surface of the supporting plate 12 is provided with a plurality of reinforcing ribs 15.

In order to improve the venting efficiency of the cavity in which the cell assembly 2 is located, a top and a bottom of the cell assembly 2 each are provided with a vent channel 16.

The cell assembly 2 includes a cell holder, and a plurality of cells mounted on the cell holder.

Preferably, each vent channel 16 has a height of not less than 3 mm.

A waterproof plug 17 is mounted in the vent 4 and moves outwardly to be disengaged from the vent 4 when the gas pressure in the cavity in which the cell assembly 2 is located rises.

The waterproof plug 17 is provided to guarantee the waterproof performance of the explosion-proof battery.

In particular, the waterproof plug 17 is fixed to the outer case 1-1 by using glue, and after the glue is solidified, the waterproof plug 17 can play a role of sealing and waterproofing. When the gas pressure in the cavity in which the cell assembly 2 is located rises, the gas pressure pushes the waterproof plug 17 to be disengaged from the vent 4, thereby discharging gas to the outside of the battery case 1 from the vent 4.

The pressure value at which the waterproof plug 17 is pushed out is not greater than the pressure value at which the closure plate 3 is pushed, and the waterproof plug 17 only plays a waterproof role, and the smaller the pressure value at which the waterproof plug 17 is pushed out, the better.

The vent 4 may be disposed at any side of the outer case 1-1, preferably, the vent 4 is disposed downwardly, when the explosion-proof battery is placed in a battery compartment of an electric golf trolley, the vent 4 faces downwardly, and the bottom of the battery compartment is provided with an exhaust hole corresponding to the vent 4, which facilitates the detachment of the waterproof plug 17 and the discharge of gas, and the gas is discharged downwardly, thereby avoiding injury to personnel.

In order to facilitate the connection of the explosion-proof battery to the electric golf trolley and an external power source, the end plate 1-2 at an end not provided with the closure plate 3 is externally provided with a connector box 18, and a lithium battery plug 19 is disposed inside the connector box 18.

In this embodiment, the connector box 18 is connected to the end plate 1-2 at the end where the connector box 18 is located by screws 20.

In particular, a charging interface 21 of the lithium battery plug 19 is located at an end of the explosion-proof battery, and a discharging interface 22 of the lithium battery plug 19 is located at a bottom of the explosion-proof battery.

The connector box 18 is provided with windows corresponding to the charging interface 21 and the discharging interface 22, respectively.

The charging interface 21 is used to be connected with an external power source, and the discharging interface 22 is used to be connected with an electric vehicle such as an electric golf trolley.

Wire passing holes 23 are disposed in the end plate 1-2 at the end where the connector box 18 is located, and a power wire of the lithium battery plug 19 is connected to the cell assembly 2 through the wire passing holes 23.

In this embodiment, the wire passing holes 23 are located at the top of the corresponding end plate 1-2.

In order to facilitate installation of the explosion-proof battery, the connector box 18 is provided with a locking protrusion 24 capable of extending from a top of the explosion-proof battery, the locking protrusion 24 is provided with a release tab 25 extending from an inside of the connector box 18, and a top of the locking protrusion 24 is provided with a locking spring 26.

Preferably, an inner side surface of the locking protrusion 24 is a slope that is high inside and is low outside.

When the explosion-proof battery in this embodiment is mounted on a corresponding electric golf trolley, the explosion-proof battery is loaded into a battery compartment in a body from a rear side of the body of the golf trolley, the locking protrusion 24 will move downwards and compress the locking spring 26 through the design of the slope during loading, and is then retracted into the connector box 18, and after the explosion-proof battery is loaded into the battery compartment, the locking protrusion 24 extends upward under the action of the locking spring 26 to be reset, and is fitted into a locking groove matched with the locking protrusion 24 at the bottom of the battery compartment. At this time, the explosion-proof battery can be firmly assembled.

When it is necessary to take out the explosion-proof battery, the release tab 25 can be pulled downward, and the release tab 25 drives the locking protrusion 24 to move downward and compresses the locking spring 26. At this time, the locking protrusion 24 can be withdrawn from the locking groove, and then the explosion-proof battery can be withdrawn from the battery compartment, which is convenient and simple to operate.

In order to ensure the explosion-proof performance of the battery case 1, the battery case 1 is made of a metal sheet material.

Preferably, the battery case 1 is made of an aluminum alloy plate, which is light in weight and high in strength.

The explosion-proof battery for electric vehicles is applied to an electric golf trolley.

When the explosion-proof battery for electric vehicles in this embodiment is applied to the electric golf trolley, the vent 4 faces downward, so that high-temperature gas can be discharged downward during venting and pressure relief, thereby preventing damage to other parts of the electric golf trolley.

During use of the explosion-proof battery, if thermal runaway occurs, the gas pressure in the cavity in which the cell assembly 2 is located in the battery case 1 rises instantaneously, and the gas pressure pushes the closure plate 3 to move toward the side at which the venting cavity 6 is located, and compress the springs 8. At this time, the springs 8 play a buffer role on the closure plate 3 so as to communicate the cavity in which the cell assembly 2 is located with the vent 4, and the gas can be discharged to the outside of the battery case 1 through the vent 4 after pushing out the waterproof plug 17, thereby effectively preventing explosives from being splashed at will, preventing a fire, and improving the use safety of the battery and the electric golf trolley.

Secondly, the present disclosure also provides an electric golf trolley based on the above explosion-proof battery for electric vehicles, the electric golf trolley using the above explosion-proof battery for electric vehicles.

### Embodiment 2

On the basis of Embodiment 1, this embodiment further provides an explosion-proof battery for electric vehicles, the structure of which is substantially the same as that in Embodiment 1, except that:
two closure plates 3 are provided and are respectively located at inner sides of the two end plates 1-2.

The arrangement of structures such as the closure plate 3 at an end not provided with the lithium battery plug 19, the vent 4, the venting cavity 6, the supporting plate 12 and the springs 8 can refer to that in Embodiment 1.

The closure plate 3 located at the same end as the lithium battery plug 19 is also similar to that in Embodiment 1, and a specific manner is as follows:
the closure plate 3 is located at the inner side of the end plate 1-2, and the venting cavity 6 is also formed between the closure plate 3 and the end plate 1-2, the venting cavity 6 is provided with the springs 8 mounted on the inner wall of the end plate 1-2, and the vent 4 is located in the outer case at the bottom of the venting cavity 6. An inner side of the closure plate 3 is provided with the supporting plate 12 assembled on the end plate 1-2, and the supporting plate 12 is provided with the vent windows 13.

Since the top of the end plate 1-2 at the end is provided with the wire passing holes 23, the closure plate 3 can avoid the wire passing holes 23, i.e., the top of the closure plate 3 does not need to be disposed in the positions of the wire passing holes 23, but the closure plate 3 must be able to completely cover the vent windows 13 in the supporting plate 12. The top of the supporting plate 12 also needs to be provided with holes corresponding to the wire passing holes 23 and accommodating the power wire to pass through.

When thermal runaway occurs in the explosion-proof battery, the gas pressure in the cavity in which the cell assembly is located rises, which simultaneously pushes the closure plates 3 at both ends thereof to move opposite to each other (toward the corresponding end plates 1-2), thereby allowing gas to be discharged from the vents 4 at both ends of the battery case 1.

Embodiment 3

On the basis of Embodiment 1, this embodiment further provides an explosion-proof battery for electric vehicles, the structure of which is substantially the same as that in Embodiment 1, except that:
each elastic element is an elastic piece.

At least one end of the elastic piece is mounted on the closure plate 3 or the end plate 1-2 corresponding thereto.

In this embodiment, both ends of the elastic piece are respectively connected to an outer wall of the closure plate 3 and an inner wall of the corresponding end plate 1-2.

The elastic piece may be selected from, but is not limited to, V-shaped or Z-shaped elastic pieces, and both ends of the elastic piece may be correspondingly connected to the closure plate 3 and the end plate 1-2 by welding or connection via screws 20.

In this embodiment, four elastic pieces are provided and are respectively located close to four corners of the closure plate 3. Arranging the elastic pieces in this manner ensures stability the closure plate 3 during movement and avoids the problem of deviation.

Embodiment 4

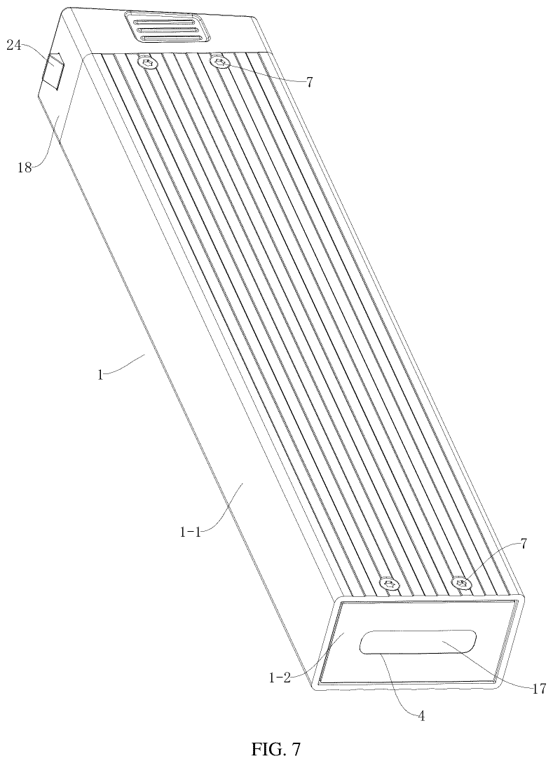

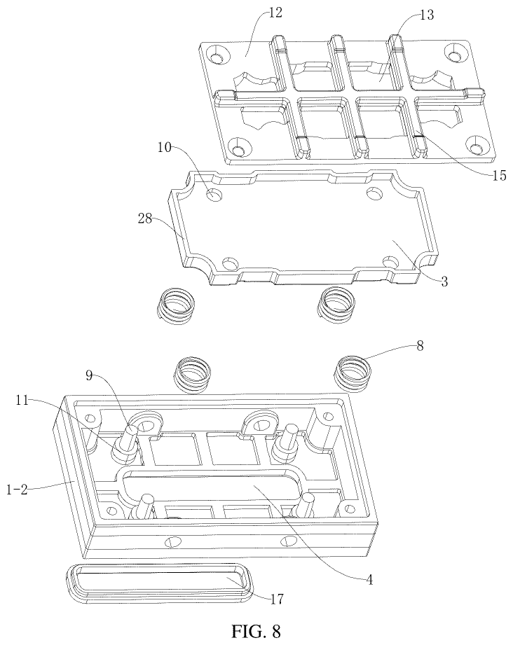

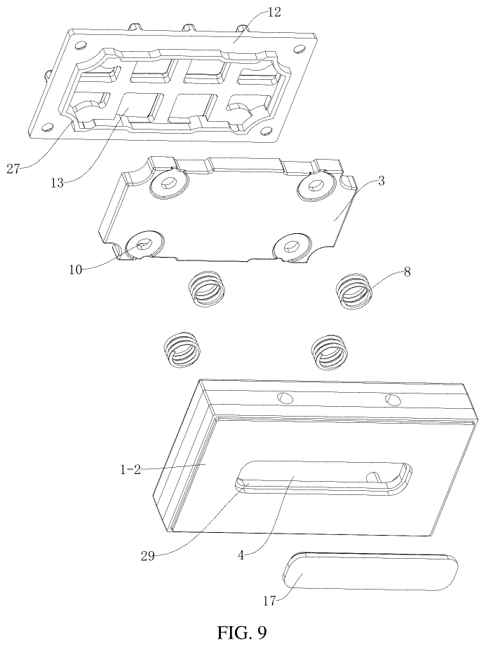

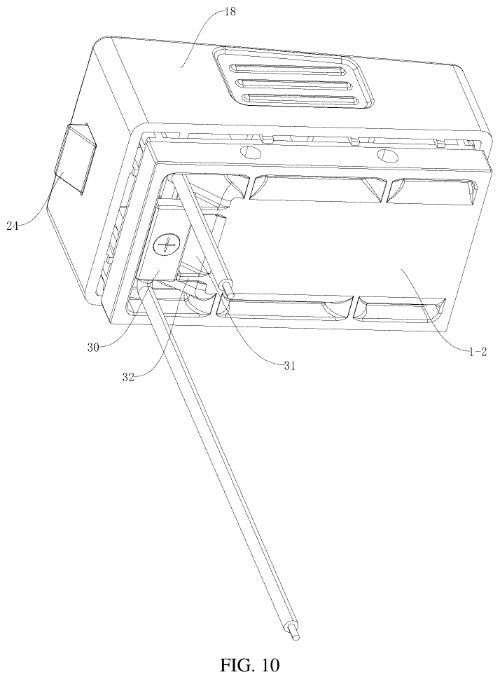

As shown in FIGS. 7 to 10, on the basis of Embodiment 1, this embodiment further provides an explosion-proof battery for electric vehicles, the structure of which is substantially the same as that in Embodiment 1, except that:
the vent 4 is disposed in the end plate 1-2, in particular the end plate 1-2 at the end where the closure plate 3 is located.

In particular, the venting cavity 6 is formed between the end plate 1-2 and the closure plate 3 on the inner side of the end plate 1-2, the vent 4 is directly disposed in the end plate 1-2, and when the gas pressure in the cavity in which the cell assembly 2 is located rises instantaneously, the gas pressure pushes the closure plate 3 to move toward the side at which the venting cavity 6 is located and compress the springs 8. The closure plate 3 is separated from the supporting plate 12 to enlarge a gap therebetween, and the gas enters the venting cavity 6 through the gap, and is then discharged directly from the vent 4 to the outside of the explosion-proof battery.

Specifically, in this embodiment, a side, facing the closure plate 3, of the supporting plate 12 is provided with a first flange 27, and the first flange 27 surrounds the periphery of the vent windows, a side, facing the supporting plate 12, of the closure plate 3 is provided with a second flange 28 that is completely matched with the shape of the first flange 27, when the explosion-proof battery is normally used, the first flange 27 is attached to the second flange 28, and when the gas pressure in the cavity in which the cell assembly 2 is located rises instantaneously, the gas pressure pushes the closure plate 3 to move in a direction away from the supporting plate 12, the first flange 27 and the second flange 28 are separated, and the gas can be vented.

Due to the design of the first flange 27 on the supporting plate 12, and the design of the second flange 28 matched with the first flange 27 on the closure plate 3, when the cell assembly 2 explodes or the like due to thermal runaway, gas will first impact the closure plate 3 from the front, then turn to impact the second flange 28, and finally turn once, that is, the gas bypasses the second flange 28 and is discharged from a gap between the first flange 27 and the second flange 28 to the venting cavity 6. During this process, the gas will undergo three turns, and the gas generated by the explosion can be more effectively prevented from being directed toward the vent, thereby better limiting the combustion and explosion of the cell assembly in the battery case, preventing explosives from being splashed out, preventing the fire situation, and improving the safety performance.

In addition, the closure plate 3 and the supporting plate 12 may also directly adopt the structures of the closure plate 3 and the supporting plate 12 disclosed in Embodiment 1.

In this embodiment, the vent 4 is a stepped hole, i.e., a portion close to its inner side is provided with a step 29 extending into the vent 4 so as to limit the installation of the waterproof plug 17.

In addition, in this embodiment, an upper portion of the end plate 1-2 at the end where the closure plate 3 is not designed is provided with a ramp extending in the direction of the connector box 18, the wire passing holes 23 are located above the ramp 31, the ramp 31 is provided with a supporting bump 32, and the supporting bump 32 is provided with a fixed plate 30 shielding inner sides of the wire passing holes 23, and the power wire of the lithium battery plug 19 passes through the wire passing holes 23, and bypasses both sides of the fixed plate 30 to be connected to the cell assembly 2, and the fixed plate 30 is fixed to the end plate 1-2 by screws to fix the position of the power wire and reduce the problem of gas leakage due to its movement.

### Embodiment 5

This embodiment provides an electric golf trolley using the explosion-proof battery for electric vehicles disclosed in the above embodiments.

The explosion-proof battery for electric vehicles can be applied to various types of electric vehicles, such as an electric bicycle, an electric motorcycle, an electric tricycle, an electric scooter, an electric four-wheeled golf cart, and an electric golf trolley, and the explosion-proof battery for electric vehicles is within the scope of the explosion-proof battery protected by the present disclosure regardless of the shape and the specification.

Taking the ideal embodiments according to the present disclosure as an inspiration, through the above description, those skilled in the art can completely make various changes and modifications without departing from the spirit and scope of the present disclosure. The technical scope of the present disclosure is not limited to the contents in the description and must be determined according to the scope of the claims.

What is claimed is:

1. An explosion-proof battery for electric vehicles, comprising:
a battery case (1), wherein a cell assembly (2) is mounted inside the battery case (1); and
at least one closure plate (3), wherein one side, facing away from a cavity in which the cell assembly (2) is located, of each closure plate (3) is correspondingly provided with at least one vent (4) located in the battery case (1), wherein
when a gas pressure in the cavity in which the cell assembly (2) is located rises, the closure plate (3) moves toward the side at which the vent (4) is located, so that gas in the cavity in which the cell assembly (2) is located is discharged to an outside of the battery case (1) through the vent (4); and
when the gas pressure in the cavity in which the cell assembly (2) is located decreases, the closure plate (3) moves toward the side at which the cell assembly (2) is located until the cavity in which the cell assembly (2) is located is separated from the vent (4).

2. The explosion-proof battery for electric vehicles according to claim 1, wherein the battery case (1) comprises a cylindrical outer case (1-1), and end plates (1-2) disposed at both ends of the outer case (1-1), the closure plate (3) is located at an inner side of the end plate (1-2), and a venting cavity (6) is disposed between the closure plate (3) and the end plate (1-2) at an end where the closure plate (3) is located.

3. The explosion-proof battery for electric vehicles according to claim 2, wherein the vent (4) is disposed in an outer wall of the venting cavity (6).

4. The explosion-proof battery for electric vehicles according to claim 3, wherein the vent (4) is disposed in the outer case (1-1).

5. The explosion-proof battery for electric vehicles according to claim 3, wherein the vent (4) is disposed in the end plate (1-2).

6. The explosion-proof battery for electric vehicles according to claim 2, wherein elastic elements are disposed between the closure plate (3) and the end plate (1-2) at the end where the closure plate (3) is located.

7. The explosion-proof battery for electric vehicles according to claim 6, wherein each elastic element is a spring (8); and
the spring (8) is assembled on the closure plate (3) and/or the end plate (1-2) corresponding thereto.

8. The explosion-proof battery for electric vehicles according to claim 7, wherein convex posts (9) are disposed on an inner wall of the end plate (1-2) at the end where the closure plate (3) is located, the closure plate (3) is provided with through holes for accommodating the convex posts

(9) to pass through, and each spring (8) sleeves the corresponding convex post (9).

9. The explosion-proof battery for electric vehicles according to claim 6, wherein each elastic element is an elastic piece; and
at least one end of the elastic piece is mounted on the closure plate (3) or the end plate (1-2) corresponding thereto.

10. The explosion-proof battery for electric vehicles according to claim 1, wherein a moving travel range of the closure plate (3) is 1.5-4 mm.

11. The explosion-proof battery for electric vehicles according to claim 2, wherein an inner side of the closure plate (3) is provided with a supporting plate (12), and a plurality of vent windows (13) are disposed in the supporting plate (12); and
an inner surface of the supporting plate (12) is provided with a plurality of reinforcing ribs (15).

12. The explosion-proof battery for electric vehicles according to claim 1, wherein a top and a bottom of the cell assembly (2) each are provided with a vent channel (16).

13. The explosion-proof battery for electric vehicles according to claim 1, wherein the vent (4) is provided with a waterproof plug (17), and the waterproof plug (17) moves outwardly to be disengaged from the vent (4) when the gas pressure in the cavity in which the cell assembly (2) is located rises.

14. The explosion-proof battery for electric vehicles according to claim 2, wherein the end plate (1-2) at an end not provided with the closure plate (3) is externally provided with a connector box (18), and a lithium battery plug (19) is disposed inside the connector box (18).

15. The explosion-proof battery for electric vehicles according to claim 14, wherein a charging interface (21) of the lithium battery plug (19) is located at an end of the explosion-proof battery, and a discharging interface (22) of the lithium battery plug (19) is located at a bottom of the explosion-proof battery; and
wire passing holes (23) are disposed in the end plate (1-2) at the end where the connector box (18) is located, and a power wire of the lithium battery plug (19) is connected to the cell assembly (2) through the wire passing holes (23).

16. The explosion-proof battery for electric vehicles according to claim 14, wherein the connector box (18) is provided with a locking protrusion (24) capable of extending from a top of the explosion-proof battery, the locking protrusion (24) is provided with a release tab (25) extending from an inside of the connector box (18), and a top of the locking protrusion (24) is provided with a locking spring (26).

17. The explosion-proof battery for electric vehicles according to claim 1, wherein the battery case (1) is made of a metal sheet material.

18. The explosion-proof battery for electric vehicles according to claim 1, wherein the explosion-proof battery for electric vehicles is applied to an electric golf trolley.

19. An electric golf trolley using the explosion-proof battery for electric vehicles according to claim 1.
